(19) United States
(12) Patent Application Publication
(10) Pub. No.: US 2026/0228737 A1
(43) Pub. Date: Aug. 6, 2026

(54) SYSTEMS AND METHODS FOR GENERATING A MERCHANT TRUST SCORE

(71) Applicant: JPMORGAN CHASE BANK, N.A., New York, NY (US)

(72) Inventors: Mykola PINCHUK, San Jose, CA (US); Theban STANLEY, San Bruno, CA (US); Dhvani KANSARA, Sunnyvale, CA (US); Saron FISSEHA, Auburn, WA (US); Michael OSORIO, San Francisco, CA (US); Wenqing SHEN, South San Francisco, CA (US); Austin REITER, Southport, CT (US); Natasha DSOUZA, San Jose, CA (US); Steven BONSMA, Seattle, WA (US); Shantanu CHANDRA, Seattle, WA (US); Ryan SCHMIEDL, Bradenton, FL (US); Nick SMALLWOOD, Edmonds, WA (US)

(21) Appl. No.: 19/043,947

(22) Filed: Feb. 3, 2025

(51) Int. Cl. G06Q 20/40; G06Q 30/0601

(52) U.S. Cl. CPC G06Q 20/4016; G06Q 20/407; G06Q 30/0609

(57) ABSTRACT

The techniques described herein relate to a method including: receiving, from a score service application executed by one or more processors and by a backend server, a request for a merchant lifetime trust score for a merchant; determining one or more calibration models of a bottom layer and one or more merchant features; generating, by the determined a machine learning model, a raw score for the merchant lifetime trust score request; generating, by the score service application, a merchant lifetime trust score based on a business rule to the raw score; and blocking, by the score service application in communication with a payment processing application executed by a frontend server, a transaction based on the merchant lifetime trust score for the merchant.

### BACKGROUND

### 1. Field of The Invention

Aspects generally relate to systems and methods for generating a merchant trust score.

### 2. Description of the Related Art

A number of institutions currently provide a range of payment processing services to merchants. The institutions can sometimes assume liability for one or more transactions of the merchants, even including smaller-volume merchants. Losses are sustained by the institutions when a merchant is unable to issue refunds or cover a cost of chargebacks and the institutions must step in to provide the refunds or the chargebacks. Robust fraud prevention is needed to protect the institutions from those losses. Current fraud systems are built either around fraud rules or transaction-level models. Currently available rule-based systems are low-performant, brittle, not scalable, and are very difficult to maintain. Currently available systems based on transaction models solve these problems but cannot implement risk controls at a merchant level. Both rule-based systems and transaction-level models cannot estimate probability of merchant fraud and be used to automatically make merchant-level risk containment decisions.

Thus, there is a need for an improved system to determine a merchant trust score in a way that implements robust fraud prevention, that is scalable and maintainable, that implements risk controls at a merchant level, and can estimate probability of merchant fraud and determine and implement merchant-level risk containment decisions.

### SUMMARY

Exemplary embodiments provide systems and methods for generating a merchant trust score. In some embodiments, the techniques described herein relate to a method including: receiving, from a score service application executed by one or more processors and by a backend server, a request for a merchant lifetime trust score for a merchant; determining one or more calibration models of a bottom layer and one or more merchant features; generating, by the determined a machine learning model, a raw score for the merchant lifetime trust score request; generating, by the score service application, a merchant lifetime trust score based on a business rule to the raw score; and blocking, by the score service application in communication with a payment processing application executed by a frontend server, a transaction based on the merchant lifetime trust score for the merchant.

In some embodiments, the techniques described herein may include a method comprising: receiving, from a score service application executed by one or more processors and by a predicate module of a backend server, a request for a merchant lifetime trust score for a merchant via an application programming interface (“API”) call in response to an event; triggering, by the predicate module, a model of a model registry of the backend server, the model being selected by the predicate module based on the event and a merchant risk profile of the merchant; deploying, by a framework module, a microservice module that coordinates a number of machine learning (“ML”) models based on the triggered model; determining, by the MLT microservice module, one or more calibration models based on one or more merchant features of the merchant risk profile, the one or more calibration models matching a merchant segment of the merchant risk profile, the one or more calibration models being trained on more than one merchant risk profiles including one or more risky merchant risk profiles and one or more non-risky profiles; generating, by an onboarding risk score machine learning model and a payment behavior score machine learning model, a raw score for the merchant lifetime trust score request; generating, by the score service application, a final score based on a business rule to the raw score; and blocking, by the score service application in communication with a payment processing application executed by a frontend server, a transaction based on the final score for the merchant.

In some embodiments, the event comprises a chargeback event and/or a refund event. In some embodiments, the method may further comprise receiving, from a payment application executed by the frontend server and at the score service application, a transaction request comprising the merchant and the transaction. In some embodiments, the method may further comprise calibrating, by a calibrator model, the raw score from each of the onboarding risk score machine learning model and the payment behavior score machine learning model, based on the model and the merchant segment. In some embodiments, the method may further comprise aggregating, by an aggregator model, the calibrated scores using weighted average for each model, the weighted average depending on the event and the merchant segment. In some embodiments, the method may further comprise writing, by a database writing module, the final score and an index identifier to a database for training of the machine learning model after an update to the database for the index identifier is received.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for generating a merchant trust score, in accordance with embodiments.

FIG. 2 is a method for generating a merchant trust score, in accordance with embodiments.

FIGS. 3A-3B are diagrams of a model of generating a merchant trust score, in accordance with embodiments.

FIGS. 4A-4B are diagrams of a model of generating a merchant trust score, in accordance with embodiments.

FIG. 5 is a block diagram of a computing device for implementing certain aspects of the present disclosure.

### DETAILED DESCRIPTION

Aspects generally relate to systems and methods for generating a merchant trust score.

Disclosed are systems and methods including a suite of Machine Learning (ML) models to continuously assess the risk of merchants causing losses for one or more institutions such as a financial institution. These losses can be due to fraud risk, credit risk or risk of other adverse events resulting in us being liable for merchant's losses.

A Merchant Lifetime Trust Score (MLT) may be generated by the one or more ML models by a dynamic risk assessment tool that continuously evaluates a merchant's risk profile throughout their lifecycle. The merchant's risk profile may comprise a measurement or scaled factor of a number of attributes including one or more of controller risk, age, location, industry, entity risk, and existence, funding, and/or history of demand deposit account (“DDA”). For example, a higher or lower measurement or scaled factor may indicate a more or less trustworthy risk attribute. Controller risk may include a historical risk associated with financial transactions executed by the merchant where less verified financial transactions may indicate higher risk and more verified financial transactions may indicate lower risk. Age may include an age of a merchant's account with the financial institution where less age may mean a higher risk. Location may include a city, state, country associated with a higher risk or a lower risk. Industry may include an industry associated with a higher or lower risk score. Entity risk may include a purchaser's risk based on a purchaser's identity, payment method (e.g., credit card, third-party payment processing), and/or time of day.

Each significant action a merchant takes—such as issuing a refund, adding a new URL, or processing a payout—may trigger a recalculation of their score, ensuring that the most current and relevant data is reflected in their risk evaluation. The MLT score may benefit from a positive history, gradually improving as the merchant maintains a stable and trustworthy record. However, major negative events, like chargebacks, may result in a decrease in the score, signaling heightened risk.

The MLT score serves as a valuable resource for fraud detection within payment systems, providing a robust mechanism for identifying and mitigating potential threats. Application deployment teams can leverage the MLT score to assess the risk of merchants within a particular segment before launching a product. Similarly, lending teams can utilize the score to evaluate the risk across their merchant portfolios.

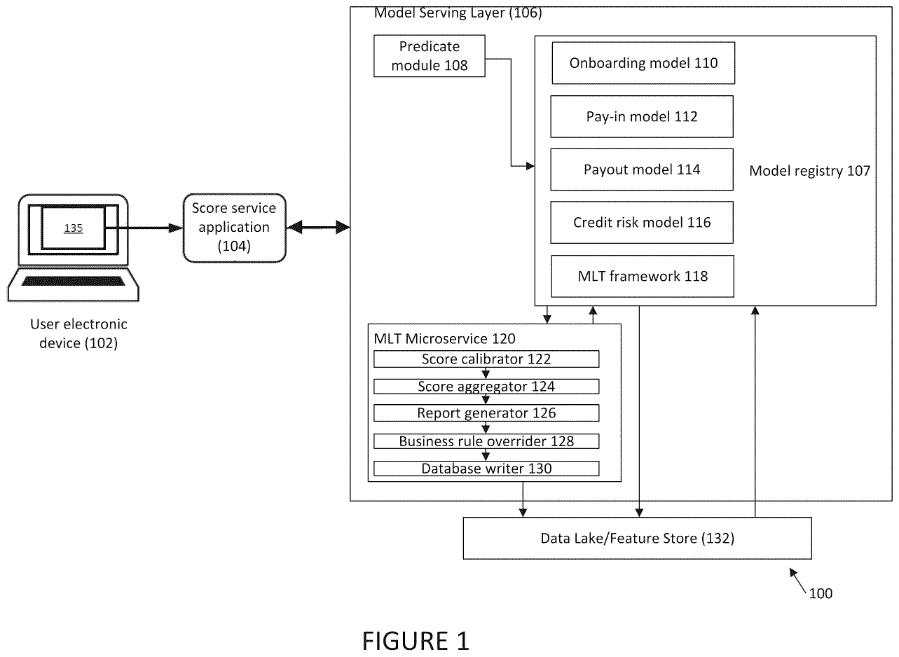

FIG. 1 is a block diagram of a system for identity proofing, in accordance with embodiments. System 100 includes a user electronic device 102 executing a score service application 104 available through a user interface 135, a model serving layer comprising a network or computer including a processor executing one or more software modules and a memory for storing data accessible by the one or more software modules and instructions to execute the one or more software modules. The one or more software modules may include one or more of a predicate module 108, a model registry 107, and a MLT microservice module 120.

The model serving layer 106 may be a computer or a server. The model serving layer 106 may be configured to access a data lake and/or a feature store 132. The model serving layer 106 may be configured to identify required data attributes (features) and request them from the feature store to proceed with risk model computation. In some embodiments, the model serving layer 106 may include one or more databases referenced by one or more of the software modules.

In accordance with aspects, user electronic device 102 may be a user electronic device such as a personal communication device (e.g., tablet, phone), computer workstation, laptop, or other electronic processing device in operative communication with score service application 104 and/or financial institution backend 106. User electronic device 102 may be configured to interact with score service application 104 through user interface 135. For instance, user device 102 may include a client application that allows a user of user electronic device 102 to interact with score service application 104. User interface 135 may include one or more graphical user interfaces to receive inputs and/or display information to the user. User interface 135 and/or score service application 104 may comprise one or more instructions executed by one or more processors of user electronic device 102. Score service application 104 may be a software production application provided by a service organization. In an exemplary aspect, score service application 104 may be a fraud prevention application or system.

In some embodiments, score service application 104 may act as a checkpoint and/or include a system checkpoint (e.g., for onboarding, pre-capture, capture). The system checkpoint may include an application programming interface (“API”) request (e.g., call) model serving layer 106 to compute a MLT score. The system checkpoint may ensure risk assessment at decision points (e.g., onboarding, payout, refund, entity update). Model serving layer 106 may respond to an API call with a MLT score. The system checkpoint may be a periodic daily checkpoint or an event-driven checkpoint (e.g., merchant onboarding to payment product, merchant onboarding to terminal payment processing, a pay-out event, a refund event, a chargeback event, an update of an attribute of a merchant). The chargeback event may be a reversal of funds to a payment account after a customer dispute.

In some embodiments, a data lake/feature store 132 may be a software module configured to respond to data requests. Data lake/feature store 132 may include a memory accessible by model serving layer 106. The memory may be a local resource such as a hard drive or may be cloud-based. Data lake/features store 132 may be part of the model serving layer 106 environment or may be hosted separately (e.g., on a different computer or server). Data lake/feature store 132 may enable model serving layer 106 uses updated information for score computation and thus may periodically or on-demand push information updates to model serving layer 106.

In some embodiments, predicate module 108 may be a software module executed by one or more processors of a computer or a server of a network, for example, a computer or a server as part of model serving layer 106.

Predicate module 108 may be configured to dynamically select appropriate models based on a merchant's profile and a checkpoint, thus ensuring relevant models are triggered. The checkpoint may be a system associated with an event such as onboarding, payout, a refund, a chargeback, or an update to a merchant's details.

In some embodiments, model registry 107 may comprise one or more software modules including an onboarding model 110, a pay-in model 112, a payout model 114, a credit risk model 116, and a MLT framework 118.

In some embodiments, onboarding model 110 may score a merchant at a time the merchant enters a payment platform in communication with score service application 104 and/or model serving layer 106. The merchant may be iteratively scored as new information is entered/arrives. Onboarding model 110 may use one or more attributes of the merchant for the score. Onboarding model 110 may generate the merchant score before the merchant starts a transaction, and so does not use transaction history. Onboarding model 110 may have lower performance than other models.

In some embodiments, pay-in model 112 may assess incoming transactions to a merchant. Pay-in model 112 may use attributes of one or more specific transactions as well as payment history of the merchant to generate and/or update the merchant score.

Payment behavioral score models, of which pay-out model 114 is one, may heavily rely on payment history of merchant. Thus, they have higher performance, but are not effective for new or relatively new merchants with short transaction history.

Credit risk model 116 may be specific to one or more merchant segments for which credit risk is a dominant source of risk. Thus, they will be trained specifically to detect merchants who are likely to cause losses for the bank due to credit events. Credit risk model 116 may heavily rely on identifying time-series patterns and trends associated with the risk of bankruptcy.

MLT framework 118 may be a software module configured to chain together outputs from the required models, facilitating complex model interactions for comprehensive risk assessment. MLT framework 118 may be a model serving layer that is a microservice. The microservice may deploy ML models to produce model scores and make them available for decision making. This layer allows different models to use outputs of each other. Thus, MLT framework 118 may deploy a model, MLT microservice module 120, that uses outputs of the underlying models which are deployed separately.

The deployed ML models may be classification ML models that predict whether JPMC deactivates a merchant due to its undesirable activity. Such activity may include fraud, bankruptcy or losses of a financial institution for any other reason (e.g., labor, funds). Different underlying models may assess different risks including merchant fraud, payer fraud, and credit risk. Each of the deployed ML models may take a set of variables or features as an input and produce a model score as an output. In other words, a model is a function which assesses the risk of a merchant based on its features. The model score lies between 0 and 1 and may be loosely interpreted as the probability that merchant is risky. The objective of a classification model is to predict a binary target variable. Therefore, the closer the model score is to 1, the higher risk a merchant poses.

There deployed ML models may include one or more of a Payment Behavior Score (PBS) model and a Onboarding Risk Score (ORS) model. The PBS may score merchants based on all attributes of merchants and their transactions.

PBS can operate at all checkpoints starting from the merchant activation day.

Because it takes all attributes and transactions into account, PBS generates a high rate of correct prediction. The ORS may score merchants based only on attributes of their legal entities and do not include transaction data. ORS may operate beginning at an onboarding attempt. ORS may be more accurate at onboarding time and possibly during a first few days upon activation.

In some embodiments, MLT microservice module 120 may comprise one or more software modules including a score calibrator 122, a score aggregator 124, a report generator 126, a business rule overrider 128, and a database writer 130. MLT microservice module 120 may calibrate, aggregate, and/or override scores to redefine them into a final MLT score as will be discussed further herein.

Score calibrator 122 may be a software module configured to map the raw model outputs (which always range between 0-1) to a final MLT score range of 0-1000. One or more calibration functions of score calibrator 122 may include applying pre-defined calibration functions that are specific to each model. These calibration functions ensure that the final MLT score is meaningful across different contexts. One or more calibration functions of score calibrator 122 may include normalization or standardization of model outputs to account for different scales and distributions of risk scores across models. Score calibrator 122 may implement and execute a calibration step for each underlying ML model to ensure that its model scores can be interpreted as probabilities and then calibration maps these probabilities to 0 -1000 scores. Calibration may be model-specific instead of segment specific. Segment-specific patterns may be accounted for by building separate models for merchant segments which exhibit different fraud patterns.

Score aggregator 124 may be a software module that generate aggregate scores from multiple underlying machine learning (ML) models. Aggregation functions of score aggregator 124 may include weighted averages, depending on the checkpoint (e.g., onboarding, pre-capture, payout) or merchant age, and the specific merchant segment or as otherwise discussed herein. Aggregation functions of score aggregator 124 may include dynamically adjusting one or more weights of individual model scores based on relevance and performance. For example, a large merchant might have a final MLT score computed by combining outputs from a credit-based model and a payer-fraud model, with each model's contribution weighted according to its predictive power and relevance to that merchant's profile. A feedback loop may be implemented to determine a predictive power score and/or a relevance score after each iteration.

Report generator 126 may be a software module configured to create one or more reports detailing a MLT score calculation process. The one or more reports may include a breakdown of the score, showing a contribution from each underlying model and the effect of a business rule applied. Report generator 126 may generate sub-scores for different risk categories (e.g., credit risk, fraud risk) are generated, providing stakeholders with a deeper understanding of the merchant's risk profile. It may include fine-grained information such as contribution of individual attributes to MLT score. This will allow different stakeholders to understand ML scores depending on their level of technical sophistication as well as level of abstraction required. Report generator 126 may be generated in one or more of a human-readable format or a machine-readable format.

Business rule overrider 128 may be a software module configured to apply business rules to override or adjust one or more ML-generated scores. One or more rules may include “when a merchant does not conduct a transaction for X time period, the MLT score should be reduced,” where reduction indicates a transaction should be blocked, not approved, or placed on hold.

Database writer 130 may be a software module configured to store MLT scores and/or associated metadata efficiently. Database writer 130 may write to a high-performance, distributed database designed for quick retrieval of historical data. Database writer 130 may employ an indexing strategy to optimize the retrieval of scores based on different criteria, such as merchant ID, timestamp, or checkpoint. Database writer 130 may manage and/or implement data retention policies. Database writer 130 may implement rules (e.g., to open more areas for storage or eliminate older files) to maintain performance (e.g., download/upload speed) over time. Database writer 130 may write to data lake/feature store 132.

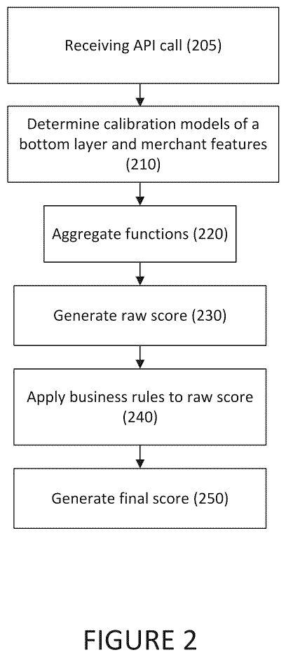

FIG. 2 is a method for identity proofing, in accordance with some embodiments. The method may be stored as a list of instructions stored on a memory that when executed by one or more processors cause the one or more processors to perform the method.

Step 210 may include receiving, from a score service application executed by one or more processors and by a backend server, a request for a MLT score for a merchant. The request may be a transmitted message packet in response to an event or recurring time (e.g., daily). The request may be an application programming interface (“API”) call. The request may be generated based on an attempt by a merchant to conduct a transaction. The score service application may determine whether to approve, block, hold, or require further verification for, the transaction based on the MLT score. The transaction may be a pay-out, a pay-in, a request for credit, a credit approval for a pending transaction, or an onboarding of the merchant to allow the merchant to make transactions on a payment application connected to the score service application.

Step 220 may include determining one or more calibration models of a bottom layer and merchant features. The merchant features may be based on the merchant conducting the transaction. The determining of the one or more calibration models may include determining a merchant segment of the merchant and determining calibration models associated with the merchant segment. The ML model may be calibrated for the merchant segment by being trained on appropriate merchant profiles of the merchant segment. Each ML model may be generated specifically on one or more merchant segments. Calibration may be a step in making model scores easier to interpret as probabilities and then mapping them to 0 -1000 scale. In other words, calibration may be model-specific rather than segment-specific.

Further, different merchant segments may have different fraud patterns. Some merchant segments may have different primary types of fraud patterns including risks which can lead to losses (e.g., collusion fraud, third-party fraud, credit risk). Thus, a single model built for many merchant segments with very different fraud patterns will likely fail to capture these patterns in a comprehensive and cohesive way. The currently disclosed systems and methods capture these risks by, among other disclosed features, building separate ML models for each segment. For example, segments with relatively small merchants can have relatively high collusion fraud risk. That is, fraudsters may onboard as merchants with an intention to defraud the payment processing platform. On the other hand, among relatively large merchants, the dominant risks are third-party fraud risk and credit risk. Relatively large merchants are less likely to be fraudulent, but are more likely to be victims of fraudsters who try to defraud legit merchants. Thus, separate ML models may be built for these two merchant types. Similarly, merchants from different geographic regions (US, Canada, Australia, EMEA) may differ both across fraud patterns and available attributes. So, separate and different ML models may be generated for different regions. A merchant segment may be a generalization of different merchant taxonomies by dimensions such as size, region, industry, or sub-platform.

A merchant segment may be based on a number of days after a first transaction. For each point in the lifecycle of a merchant, a different performance evaluation of underlying ML models may be expected, and thus ML models are calibrated to each merchant segment. Thus, the partition will determine sample for performance evaluation for each point in merchant's lifecycle. In some embodiments, linear regression may be used to calculate weights of the determined ML models.

For each perspective determined ML model, the backend server may run a logistic regression of a merchant label (e.g., good=0, bad=1) on scores from the perspective determined ML models. For example, each partition may be merchants of an age after onboarding, after a first transaction, or after a most recent transaction. In some embodiments, a regularization may be added to guarantee a small set of determined models. In some embodiments, the weights may be used if they are nonnegative. In some embodiments, the weights may be constrained to add to 1 (e.g., by scaling each weight by 1 divided by a sum of the weights).

Step 230 may include generating, by the determined ML models, a raw score for the MLT request. The raw score may be based on one or more attributes acquired from a merchant, a merchant's legal entity, and/or transaction details gathered from the payment application. The attributes for a legal entity may include an industry, a business description, a legal type, a formation date, an account, an existing demand deposit account, a timeframe of the account, and/or a balance on an account. In some embodiments, the raw score may be calibrated to a different scale. MLT scores may include one or more reasons codes. Reason codes will provide a low-level explanation for MLT score. We will use SHAP values to produce such reason codes. Each underlying ML model will generate a set of SHAP values for its features. For each feature, its SHAP value indicates how this feature value contributed to the model prediction. Thus, the most impactful features will have the highest SHAP values. Positive SHAP values mean that the given feature value contributed to model perceiving merchant as riskier. Conversely, negative SHAP values imply a decrease in perceived risk of merchant. Reason codes will be especially useful for stakeholders who need a comprehensive low-level explanation of model prediction for a specific merchant. To derive the most benefit from such explanations, stakeholders must be familiar with the meaning of the main features used by an underlying ML model.

Below is an example of such reason codes. The graph shows contributions of top 7 features to model predictions. Feature values are shown to the left from feature names at the Y-axis area. Numbers on graph bars show percentage change in estimated merchant risk due to each feature. For example, “risk_rating_controller_email_domain” feature value of 0.213 makes a merchant riskier by 4% as shown by “+4%”. This example shows feature contributions using probability scale. Alternatively, we can convert these probabilities to 0 -1000 scale by using the same mapping function as we use for score calibration.

Step 240 may include, by the score service application, applying a business rule to the raw score. Business rules may be applied by the score service application to override or adjust one or more ML-generated scores. One or more rules may include “when a merchant does not conduct a transaction for X time period, the MLT score should be reduced,” where reduction indicates a transaction should be blocked, not approved, or placed on hold.

Step 250 may include generating a final MLT score. The final MLT score may be returned to the score service application. The score service application may convert the final MLT score into a transaction-level decision including an approval decision, a hold decision, a block decision, and/or a request for more information related to a transaction. Additionally, the MLT score may be used for merchant account-level decisions such as setting minimum reserve requirements, setting amount limits on pay-in and pay-out transactions, enabling or restricting merchant payment processing capabilities (such as being able to use terminal for card-present transactions). The score service application may determine the decision based on a context for the MLT request received from a payment transaction application (e.g., a transaction comprising an onboarding request may require a lower MLT score than a transaction comprising a pay-out request and/or a credit request).

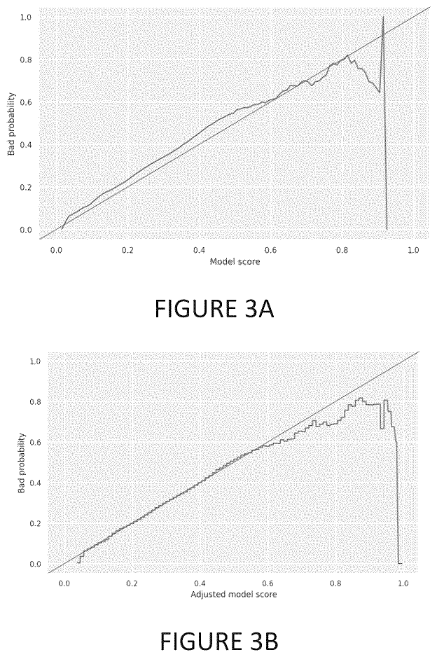

FIGS. 3A-3B are diagrams of a model of generating a merchant trust score, in accordance with embodiments. FIGS. 3A-3B may be an example of raw model scores and adjusted model scores for Payment Behavioral Score for Quick Accept platform (i.e., PBS QA) model. 99.5% of raw scores lie between 4% and 50%, so a pattern outside of this range may be disregarded. A red line is a 45-degree line corresponding to the ideal case P(bad|score)=score.

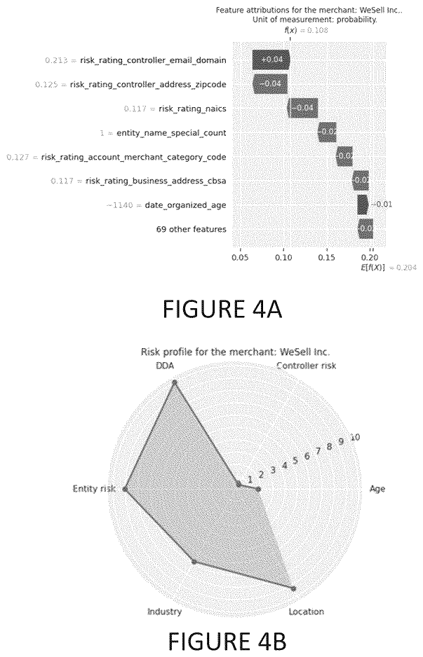

FIGS. 4A-4B are diagrams of a model of generating a merchant trust score, in accordance with embodiments. FIG. 4A may be a mapping of an exemplary merchant including each reason code and its ML-generated score graphed against probability. FIG. 4B may be a risk profile of an exemplary merchant including one or more exemplary attributes (age, location, industry, entity risk, demand account (DDA), controller risk). In some embodiments, the risk profile may be a graphic representation of a scale of each attribute.

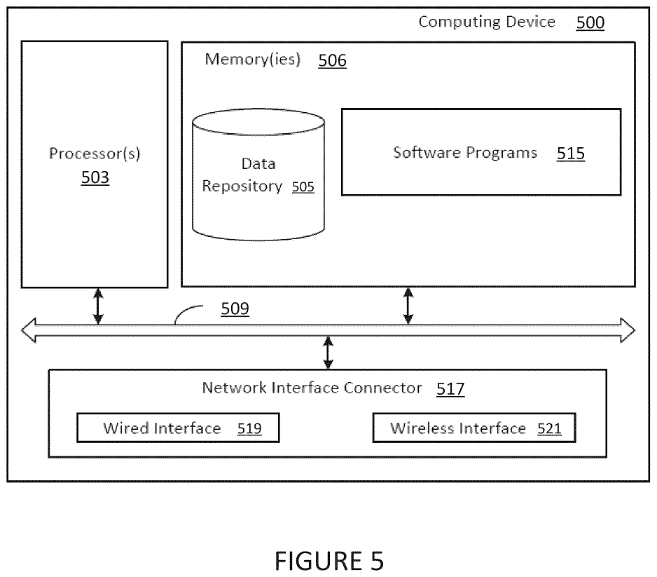

FIG. 5 is a block diagram of FIG. 5 is a block diagram of a computing device for implementing certain aspects of the present disclosure.

FIG. 5 depicts exemplary computing device 500. Computing device 500 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 500.

Computing device 500 includes a processor 503 coupled to a memory 506. Memory 506 may include volatile memory and/or persistent memory. The processor 503 executes computer-executable program code stored in memory 506, such as software programs 515. Software programs 515 may include one or more of the logical steps disclosed herein as a programmatic instruction, which can be executed by processor 503. Memory 506 may also include data repository 505, which may be nonvolatile memory for data persistence. The processor 503 and the memory 506 may be coupled by a bus 509. In some examples, the bus 509 may also be coupled to one or more network interface connectors 517, such as wired network interface 519, and/or wireless network interface 521. Computing device 500 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams.

Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above.

Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, from a score service application executed by one or more processors and by a predicate module of a backend server, a request for a merchant lifetime trust score for a merchant via an application programming interface (“API”) call in response to an event;
triggering, by the predicate module, a model of a model registry of the backend server, the model being dynamically selected by the predicate module based on the event and a merchant risk profile of the merchant;
deploying, by a framework module, a Merchant Lifetime Trust Score (“MLT”) microservice module that coordinates a number of machine learning (“ML”) models based on the triggered model, the MLT microservice module using outputs of underlying models that are deployed separately;
determining, by the MLT microservice module, one or more calibration models based on one or more merchant features of the merchant risk profile, the one or more calibration models matching a merchant segment of the merchant risk profile, the one or more calibration models being trained on more than one merchant risk profiles including one or more risky merchant risk profiles and one or more non-risky profiles;
generating, by an onboarding risk score machine learning model and a payment behavior score machine learning model, a raw score for the merchant lifetime trust score request;
calibrating, by a calibrator model, the raw score from each of the onboarding risk score machine learning model and the payment behavior score machine learning model, based on the model and the merchant segment;
aggregating, by an aggregator model, the calibrated scores using weighted average for each model, the weighted average depending on the event and the merchant segment to form aggregated scores;
generating, by the score service application, a final score based on a business rule to the aggregated scores; and
controlling, by the score service application in communication with a payment processing application executed by a frontend server, a transaction based on the final score for the merchant, wherein controlling comprises an approval decision, a hold decision, a block decision, or a request for more information related to the transaction.

2. The method of claim 1, wherein the event comprises a chargeback event.

3. The method of claim 1, wherein the event comprises a refund event.

4. The method of claim 1, further comprising receiving, from a payment application executed by the frontend server and at the score service application, a transaction request comprising the merchant and the transaction.

5. The method of claim 1, wherein calibrating comprises mapping raw model outputs, which always range between 0-1, to a final MLT score range of 0-1000.

6. The method of claim 5, wherein aggregating comprises dynamically adjusting one or more weights of individual model scores based on relevance and performance.

7. The method of claim 1, further comprising writing, by a database writing module, the final score and an index identifier to a database for training of the machine learning model after an update to the database for the index identifier is received.

8-14. (canceled)

15. A non-transitory computer readable storage medium, including instructions stored thereon, which when read and executed by one or more computer processors, cause the one or more computer processors to perform steps comprising:
receiving, from a score service application executed by one or more processors and by a predicate module of a backend server, a request for a merchant lifetime trust score for a merchant via an application programming interface (“API”) call in response to an event;
triggering, by the predicate module, a model of a model registry of the backend server, the model being selected by the predicate module based on the event and a merchant risk profile of the merchant;
deploying, by a framework module, a Merchant Lifetime Trust Score (“MLT”) microservice module that coordinates a number of machine learning (“ML”) models based on the triggered mode, the MLT microservice module using outputs of underlying models which are deployed separately;
determining, by the MLT microservice module, one or more calibration models based on one or more merchant features of the merchant risk profile, the one or more calibration models matching a merchant segment of the merchant risk profile, the one or more calibration models being trained on more than one merchant risk profiles including one or more risky merchant risk profiles and one or more non-risky profiles;
generating, by an onboarding risk score machine learning model and a payment behavior score machine learning model, a raw score for the merchant lifetime trust score request;
calibrating, by a calibrator model, the raw score from each of the onboarding risk score machine learning model and the payment behavior score machine learning model, based on the model and the merchant segment;
aggregating, by an aggregator model, the calibrated scores using weighted average for each model, the weighted average depending on the event and the merchant segment to form aggregated scores;
generating, by the score service application, a final score based on a business rule to the aggregated scores; and
controlling, by the score service application in communication with a payment processing application executed by a frontend server, a transaction based on the final score for the merchant, wherein controlling comprises an approval decision, a hold decision, a block decision, or a request for more information related to the transaction.

16. The method of claim 15, wherein the event comprises a chargeback event.

17. The method of claim 15, wherein the event comprises a refund event.

18. The method of claim 15, further comprising receiving, from a payment application executed by the frontend server and at the score service application, a transaction request comprising the merchant and the transaction.

19. The method of claim 15, further comprising calibrating, by a calibrator model, the raw score from each of the onboarding risk score machine learning model and the payment behavior score machine learning model, based on the model and the merchant segment.

20. The method of claim 19, further comprising aggregating, by an aggregator model, the calibrated scores using weighted average for each model, the weighted average depending on the event and the merchant segment.
